(19) United States
(12) Patent Application Publication
(10) Pub. No.: US 2024/0204362 A1
(43) Pub. Date: Jun. 20, 2024

(54) BUSBAR INTEGRATED WITH A TOTE OF A BATTERY ASSEMBLY

(71) Applicant: Rivian IP Holdings, LLC, Plymouth, MI (US)

(72) Inventors: Neil Patel, Costa Mesa, CA (US); Tyler Jacobs, Redondo Beach, CA (US); Katelyn Rossick, Irvine, CA (US); Brian Pham, Westminster, CA (US); Kyle Butterfield, Ladera Ranch, CA (US); Aaron Churchill, Irvine, CA (US); Ehsan Baseri, Irvine, CA (US); Karthik Gundappa Balte, Laguna Niguel, CA (US)

(73) Assignee: Rivian IP Holdings, LLC, Plymouth, MI (US)

(21) Appl. No.: 18/067,768

(22) Filed: Dec. 19, 2022

(51) Int. Cl. H01M 50/507; B60L 50/64; H01M 50/204; H01M 50/509; H01M 50/517

(52) U.S. Cl. CPC H01M 50/507; B60L 50/64; H01M 50/204; H01M 50/509; H01M 50/517; H01M 2220/20

(57) ABSTRACT

A battery system having busbars integrated with a tote is provided. The battery system can include a first pin located on a busbar or a tote and a first receptacle on the busbar or the tote. The first receptacle can include a first opening having a first size in a first direction that is greater than or equal to a first size of the first opening in a second direction. A second pin and a second receptacle can be located on the busbar or the tote. The second receptacle can include a second opening having a second size in the first direction that is less than or equal to a second size of the second opening in the second direction to align the busbar with the tote via the first pin inserted into the first receptacle and the second pin inserted into the second receptacle.

### INTRODUCTION

Electric vehicles (EVs) can be powered using batteries that store energy to reduce greenhouse gas emissions. The batteries can include different components facilitating energy storage and distribution.

### SUMMARY

This disclosure is generally directed to a solution for integrating busbars of a battery system with a tote in a battery assembly of an electric vehicle. Integrating busbars with a tote of a battery assembly during the manufacturing process can be complicated and time consuming. The present solution provides physical alignment features to efficiently integrate busbars with a tote of a battery module, battery pack or other parts of the battery assembly in a simpler and more efficient process using sets of pins and their corresponding receptacles. To provide additional improvements, the busbars of the present solution can also include integrated pierce nuts, clips for cable restraint, brackets for boards or to support wires, or busbar features for providing electrical isolation to the busbars in the battery assembly. For example, a busbar or a tote can be provided a pin or a corresponding receptacle for receiving the pin during the alignment and assembly process. The busbar or the tote can include a second pin and a second receptacle for receiving the second pin. By inserting the pins into their corresponding receptacles, the integration and interfacing of the busbar with the tote can be improved. The busbars of the present solution can further include nut plates with integrated pierce nuts, clips for restraining cables and bracket features to support one or more boards or wires. The busbars can further include curved portions for isolating the busbar from electrically charged parts of the battery. The integration and assembly features of the present solution can provide a more efficient and reliable integration of the busbars with the tote in a battery module, while improving the performance of the battery.

At least one aspect is directed to a battery system. The battery system can include a busbar and a tote configured to align with the busbar via a multi-dimensional locator. The multi-dimensional locator can be formed of one or more pins and one or more receptacles configured to receive the one or more pins.

At least one aspect can be directed to a battery module. The battery module can include a busbar of a battery module and a tote of the battery module. The battery module can include a first pin that can be located on one of the busbar or the tote. The battery module can include a first receptacle located on one of the busbar or the tote. The first receptacle can include a first opening having a first size in a first direction that is greater than or equal to a first size of the first opening in a second direction. The battery module can include a second pin that can be located on one of the busbar or the tote. The battery module can include a second receptacle that can be located on one of the busbar or the tote, The second receptacle can include a second opening having a second size in the first direction that is less than or equal to a second size of the second opening in the second direction to align the busbar with the tote via the first pin inserted into the first receptacle and the second pin inserted into the second receptacle.

At least one aspect is directed to a method. The method can include providing a busbar of a battery system. The method can include providing a tote of the battery system. The tote configured to align with the busbar via a multi-dimensional locator. The multi-dimensional locator can be formed of a one or more pins and one or more receptacles configured to receive the one or more pins.

At least one aspect is directed to a method. The method can include forming a first pin on one of the busbar or the tote. The method can include forming, on one of the busbar or the tote, a first receptacle. The first receptacle can include a first opening having a first size in a first direction that is greater than or equal to a first size of the opening in a second direction. The method can include forming a second pin on one of the busbar or the tote. The method can include forming, on one of the busbar or the tote, a second receptacle. The second receptacle can include a second opening having a second size in the first direction that is greater than or equal to a second size of the opening in the second direction. The method can include aligning the busbar with the tote via the first pin inserted into the first receptacle and the second pin inserted into the second receptacle.

At least one aspect is directed to an electric vehicle. The electric vehicle can include a battery system. The battery system can include a busbar and a tote. The tote can be configured to align with the busbar via a multi-dimensional locator. The multi-dimensional locator can be formed of a one or more pins and one or more receptacles configured to receive the one or more pins.

At least one aspect is directed to an electric vehicle. The electric vehicle can include a battery pack of an electric vehicle that can include a battery module. The battery module can include a busbar of the battery module and a tote of the battery module to provide support for the busbar. The battery module can include a first pin located on one of the busbar or the tote. The first receptacle can be located on one of the busbar or the tote. The first receptacle can include a first opening having a first size in a first direction that is greater than or equal to a second size of the first opening in a second direction to align the busbar with the tote. The battery module can include a second pin located on one of the busbar or the tote. The battery module can include a second receptacle located on one of the busbar or the tote. The second receptacle can include a second opening having a second size in the first direction that is less than or equal to a second size of the second opening in the second direction to align the busbar with the tote in at least the first direction and the second direction via the first pin inserted into the first receptacle and the second pin inserted into the second receptacle.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle.

FIG. 2A depicts an example of one or more battery packs.

FIG. 2B depicts an example of one or more battery modules.

FIG. 2C depicts a cross sectional view of a battery cell.

FIG. 2D depicts a cross sectional view of a battery cell.

FIG. 2E depicts a cross sectional view of a battery cell.

FIG. 3 depicts a front-side view of an embodiment of a battery module.

FIG. 4 depicts a rear-side view of an embodiment of a battery module.

FIG. 5 depicts an example of a battery module with the positive and negative busbars interfaced with the tote using pins and receptacles.

FIG. 6 depicts a close-up view of a battery module with the series busbar interfaced with the tote using pins and receptacles.

FIG. 7 depicts an example of a close-up of the pins and receptacles arranged as two-way locators and four-way locators.

FIG. 8 depicts a perspective view of a negative busbar.

FIG. 9 depicts a perspective view of a positive busbar.

FIG. 10 depicts an example of a battery module with integration features of the negative and positive busbars.

FIG. 11 depicts a zoom-in view of a clip for restraining a cable on a busbar.

FIG. 12 depicts a perspective view of a battery module with negative and positive busbars interfaced and assembled into the battery module.

FIG. 13 is a flow diagram illustrating an example method of aligning a busbar with a tote of a battery module.

### DETAILED DESCRIPTION

Following below are more detailed descriptions of various concepts related to, and implementations of, methods, apparatuses, and systems of integrating busbars of with a tote of a battery module assembly electrically in a battery pack of an electric vehicle. The various concepts introduced above and discussed in greater detail below may be implemented in any of numerous ways.

This disclosure is generally directed to interfacing features of busbars for integration with a tote in a battery system of an electric vehicle (EV). An EV can include a battery pack that can have one or more interconnected battery modules for powering an EV. Each of the battery pack or battery modules can include any number of battery cells storing energy. The battery modules can transfer electrical power to and from the battery cells via electrically conductive busbars of the battery modules. However, integrating busbars with a tote of a battery module assembly during the manufacturing process can be difficult and time consuming. For example, it can be challenging to efficiently align and couple a busbar with a tote of a battery module in a finite enclosure without introducing inefficiencies or negatively impacting performance of other components in the battery module.

The present solution provides physical alignment features, such as pins and receptacles, for efficiently integrating busbars of a battery system with a tote of the battery system in a simpler and more efficient manufacturing process. The busbar of the present solution can further include integrated pierce nuts, clips for cable restraint, brackets for boards or wires support as well as electrical isolation of the busbars. Each one of the tote and the busbar can include one or more pins and receptacles for receiving the pins during the alignment of the busbar with the tote of the battery system. For example, each tote and the busbar to be integrated with the tote can include one of a pin or a receptacle for receiving the pin. The busbar and the tote can each also include a second pin and a second receptacle for receiving the second pin. The two sets of pins and receptacles can facilitate a more efficient manufacturing and assembly of the battery system by setting, locking, placing, affixing, disposing, aligning or otherwise interfacing the busbars and the tote. The busbars of the present solution can also include a nut plate with an integrated pierce nut, a clip for restraining cables and bracket features to support one or more boards or wires. The busbars can further include curved portions for isolating the busbar from electrically charged parts of the battery system.

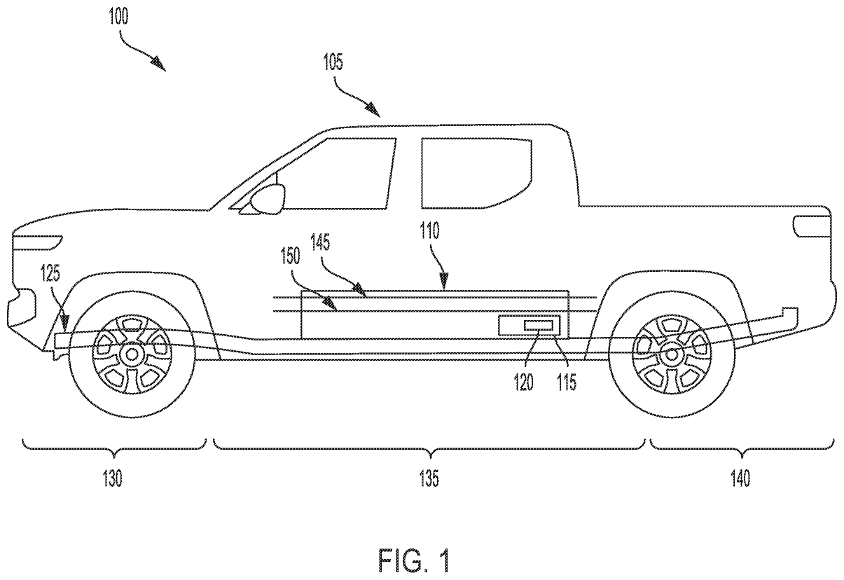

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

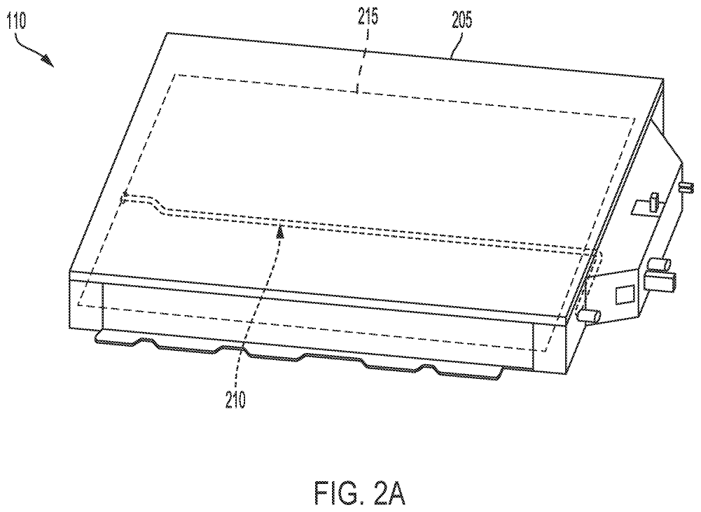

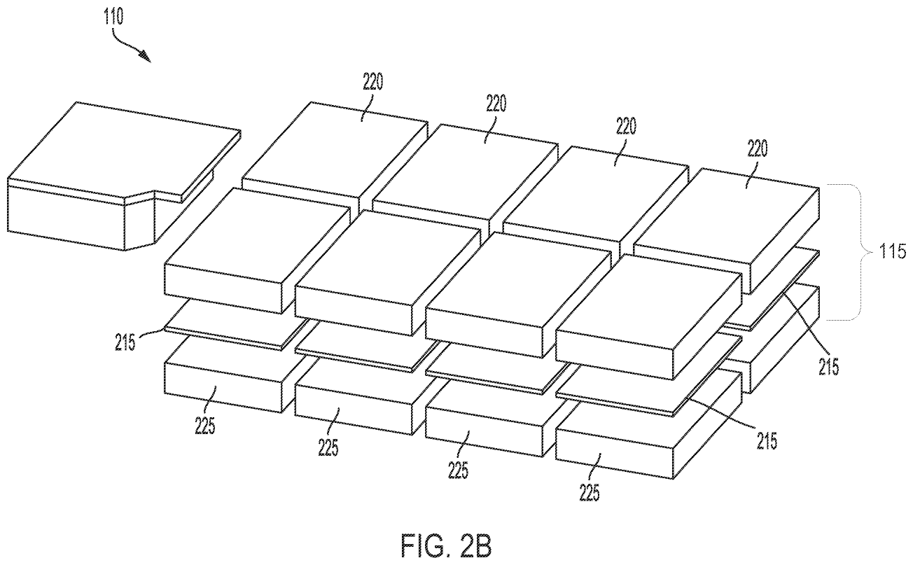

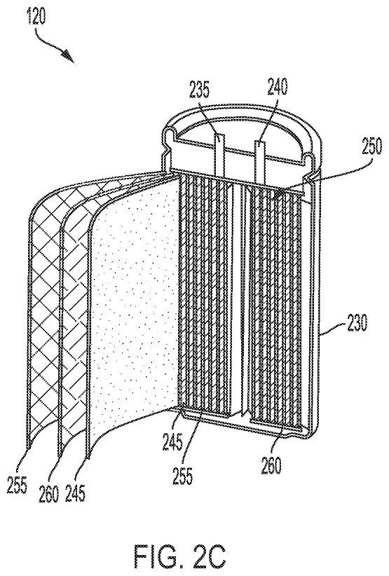

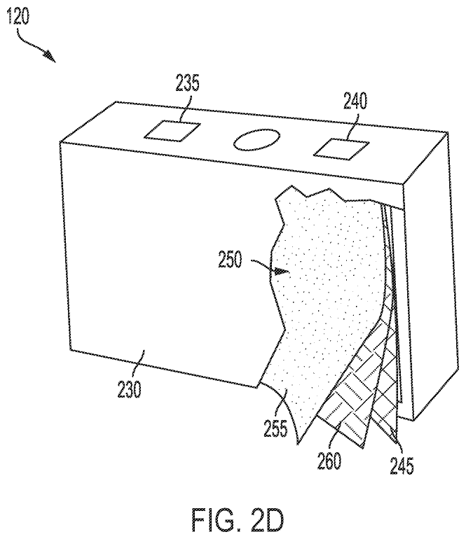

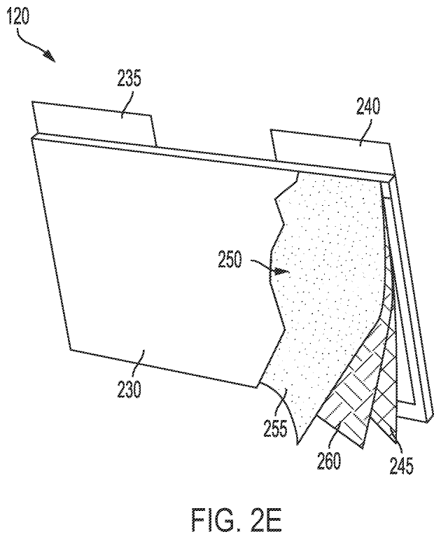

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIGS. 2C, 2D and 2E depict an example cross sectional view of a battery cell 120. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

Battery cells 120 have a variety of form factors, shapes, or sizes. For example, battery cells 120 can have a cylindrical, rectangular, square, cubic, flat, pouch, elongated or prismatic form factor. As depicted in FIG. 2C, for example, the battery cell 120 can be cylindrical. As depicted in FIG. 2D, for example, the battery cell 120 can be prismatic. As depicted in FIG. 2E, for example, the battery cell 120 can include a pouch form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105. Battery cells 120 can operate at any voltage range, such as positive or negative 1V, 2V, 3V, 5V, 9V, 12V or any other voltage range above 12V.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LixPOyNz). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li_{2S}—SiS₂, Li₂S—P₂S₅, Li₂S—GeS₂, Li10GeP2S12) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted in FIG. 2C, among others), elliptical, or ovular base, among others. The shape of the housing 230 can also be prismatic with a polygonal base, as shown in FIG. 2D, among others. As shown in FIG. 2E, among others, the housing 230 can include a pouch form factor. The housing 230 can include other form factors, such as a triangle, a square, a rectangle, a pentagon, and a hexagon, among others. In some embodiments, the battery pack may not include modules. For example, the battery pack can have a cell-to-pack configuration wherein battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic (e.g., as depicted in FIG. 2D, among others) or cylindrical (e.g., as depicted in FIG. 2C, among others), the housing 230 can include a rigid or semi-rigid material such that the housing 230 is rigid or semi-rigid (e.g., not easily deformed or manipulated into another shape or form factor). In examples where the housing 230 includes a pouch form factor (e.g., as depicted in FIG. 2E, among others), the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also release lithium ions during the discharging of the battery cell 120. Conversely, the cathode layer 255 can receive electrical current into the battery cell 120 and can output electrons during the charging of the battery cell 120. The cathode layer 255 can receive lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. The electrolyte layer 260 can help transfer ions between the anode layer 245 and the cathode layer 255. The electrolyte layer 260 can transfer Li⁺ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (Li M PO4, M=Fe and/or Co and/or Mn and/or Ni)) chemistry, LISICON or NASICON Phosphates (Li3M2(PO4)3 and LiMPO4Ox, M=Ti, V, Mn, Cr, and Zr), for example Lithium iron phosphate (LFP), Lithium iron manganese phosphate (LMFP), a layered oxides (LiMO2, M=Ni and/or Co and/or Mn and/or Fe and/or Al and/or Mg) examples NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li1+xM1-xO2) (Ni, and/or Mn, and/or Co), (OLO or LMR), spinel (LiMn2O4) and high voltage spinels (LiMn1.5Ni0.5O4), disordered rock salt, Fluorophosphates Li2FePO4F (M=Fe, Co, Ni) and Fluorosulfates LiMSO4F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrins (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO3 (A=Li, Ca, Sr, La, and B=Al, Ti), garnet-type with formula A3B2(XO4)3 (A=Ca, Sr, Ba and X=Nb, Ta), lithium phosphorous oxy-nitride (LixPOyNz). In some embodiments, the solid electrolyte layer can include a glassy, ceramic and/or crystalline sulfide-based electrolyte (e.g., Li3PS4, Li7P3S11, Li2S—P2S5, Li2S—B2S3, SnS—P2S5, Li2S—SiS2, Li2S—P2S5, Li2S—GeS2, Li10GeP2S12) and/or sulfide-based lithium argyrodites with formula Li6PS5X (X=Cl, Br) like Li6PS5Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

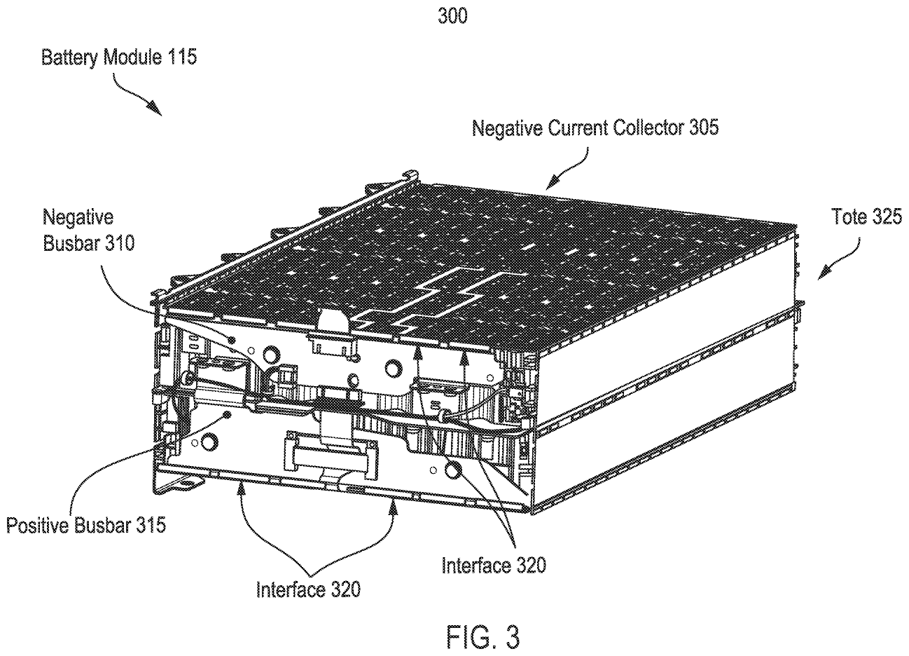

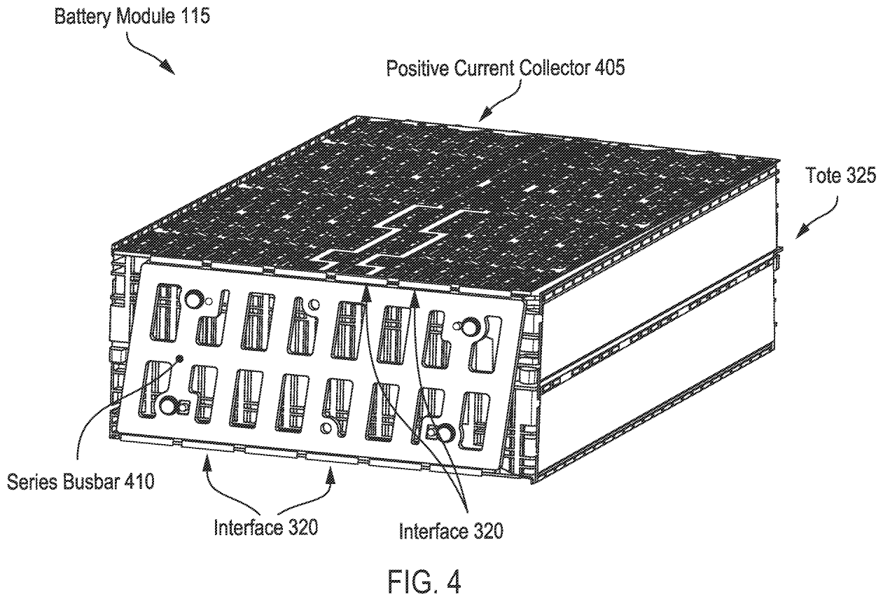

FIG. 3 depicts a front perspective view of an example battery module 115 of a battery system 300. FIG. 4 depicts a rear perspective view of the example battery module 115. The battery module 115 illustrated in FIGS. 3 and 4 can be included in a battery pack 110 of an EV 105, along with any number of battery modules 115. The battery module 115 can include one or more totes 325 that can include or provide structure to support, hold or carry thereon one or more current collectors, such as a negative current collector 305 or a positive current collector 405. The tote 325 can also include or provide support structure to support, hold or carry thereon one or more busbars, such as a negative busbar 310, a positive busbar 315 or a series busbar 410. For example, the current collectors 305 or 405 and the busbars 310, 315 or 410 can each be supported on the outer surface of a cuboid shaped tote 325. Providing electrical coupling between any of the current collectors 305 or 405 and the busbars 310, 315 or 410 are one or more interface components 320, which can also be referred to as the interfaces 320. Interface components 320 can be electrically coupled to the current collectors 305 or 405 and to the busbars 310, 315 or 410 in a variety of ways, such as via weld or soldering contacts, connectors, clips, or other forms of electrical coupling or attachment, or by being an integral component of a current collector 305 or 405, or a busbar 310, 315 or a 410.

FIG. 3 depicts a front-side perspective of an example battery system 300 in which a tote 325 of a battery module 115 can support a negative current collector 305 on one of its outer surfaces. The battery module 115 can support a negative current collector 305 on one of its outer perimeters that can be offset with respect to the outer surfaces of the tote 325 by set offset or distance apart. For example, a tote 325 can include a top outer surface or a top outer perimeter at which the negative current collector 305 can sit, be disposed on, be affixed to, or otherwise provided on a structure that provides an offset between the negative current collector 305 and the tote 325. For example, an outer surface of the tote 325 can include a surface on which a current collector 305 or 405 can be affixed or attached directly on the surface. Current collectors 305 or 405 can be affixed or disposed at an outer perimeter that can be defined or offset with respect to an outer surface of the tote 325, such as for example via pins that a set distance apart from the outer surface of the tote 325 on which, or over which, the current collector 305 or 405 is disposed.

The tote 325 can further support on its side outer surface, or its side outer perimeter, one or more busbars, such as the negative busbar 310 and the positive busbar 315. The top outer surface or a perimeter can share an edge with a side outer surface or a perimeter, at which, or about which, one or more interface components 320 can curve or bend in order to provide electrical coupling between the negative current collector 305 and the negative busbar 310. The interface components 320 can be integral parts of the negative current collector 305. For example, interface components 320 can be tabs or portions of a metal sheet layer of the current collector 305 that protrudes from the remained of the metal sheet within the current collector. The interface components 320 can protrude or extend from a portion of the negative current collector 305. The interface components 320 can be curved or bent about an edge of a busbar, such as a negative busbar 310, positive busbar 315 or series busbar 410. The interface components 320 can be curved about or above the corner edge of the tote 325 or the battery module 115. The interface components 320 can be attached to the negative busbar 310, or the positive busbar 315 or the series busbar 410. The interface components 320 can be attached to the busbars 310, 315 or 410, for example, via any one or more of welding, soldering, physical attachment, clips, connectors, locking mechanism or otherwise creating a physical coupling or a contact between the interface component 320 and the busbar 310, 315 or 320.

FIG. 4 depicts a rear-side perspective view of an example battery module 115 in which the tote 325 provides a structure for supporting on its bottom outer surface or a bottom outer perimeter, a positive current collector 405. The positive current collector 405 can be disposed, affixed or supported on the outer bottom surface of the tote 325 or its outer perimeter. The side, or the outer surface or perimeter on which the positive current collector 405 is disposed, affixed or supported can be opposite to the outer top surface or its perimeter on which the negative current collector 305 is disposed, affixed or supported. For example, the negative current collector 305 and the positive current collector 405 can be supported on opposite sides, planes or faces of the battery module 115. Similarly, the series busbar 410 can be disposed, affixed or supported on a side surface of the tote 325 or its perimeter that is opposite to the side surface of the tote 325 or its perimeter on which the negative busbar 310 and the positive busbar 315 are disposed, affixed or supported. For example, the series busbar 410 can be supported on opposite sides, planes or faces of the battery module 115 from the positive and negative busbars 315 and 310.

Series busbar 410 can be electrically coupled with both the positive current collector 405 and the negative current collector 305, via one or more interfaces 320. For example, one or more interface components 320 can be curved about or bent over an edge of the busbar 410 or the corner of the tote 325 or the battery module 115. Series busbar 410 can be electrically coupled with the negative current collector 305, via one or more interfaces 320 along another edge of the series busbar 410. For example, the series busbar 410 can have one or more interfaces 320 from a positive current collector 405, or coupled to the positive current collector 405, that are also electrically coupled with the series busbar 410 along one edge of the series busbar 410. The series busbar 410 can include another one or more interfaces 320 from a negative current collector 305, or coupled with the negative current collector 305, that are coupled with the series busbar 410 along another edge of the series busbar 410. The series busbar 410 can provide electrical continuity between the negative current collector 305 and the positive current collector 405. The series busbar 410 can provide electrical insulation between the negative current collector 305 and the positive current collector 405. The two edges of the series busbar 410 along which, or via which, the series busbar 410 can be electrically coupled with both the current collectors 305 and 405 can be edges that are opposite to each other, such as for example two opposite edges of a rectangular metal plate that can form the busbar 410. The series busbar 410 can include any other shaped metal plate, including square, rectangular, elliptical, triangular, pentagonal or any the shape of any other polygon.

Battery module 115 and its components can be shaped in a variety of ways. Illustrated in FIGS. 3 and 4 is an example battery module 115 shaped as a cuboid or a rectangular prism. The battery module 115 can be any shape, such as a cube, a pyramid, a trigonal prism, a tetragonal prism, tetrahedron, decahedron, dodecahedron, or any other polyhedron, a sphere, a semi-sphere, a cylinder or other geometric shape, for example. The shape can be defined by any number of battery module 115 components, such as tote 325, current collectors 305, 405 and busbars 310, 315 or 410. For example, the tote 325 can be shaped as a rectangular prism and can support on its outer surfaces or perimeters any number of more current collectors 305 or 405, busbars 310, 315 or 410 and interfaces 320. For example, tote 325 can support, or carry thereon, a negative current collector 305, which can be affixed to or disposed on a surface or a perimeter from the surface of the tote 325 as well as a negative busbar 310 on a side surface or a perimeter from the side surface of the tote 325. The interface components 320 can be curved or bent over the edge of the tote 325 or the edge of the negative busbar 310, thereby electrically coupling the negative current collector 305 to the negative busbar 310 over the edge of the tote 325 or the edge of the busbar, such as 310, 315 or 410. For example, tote 325 can support or carry thereon a positive current collector 405, which can be affixed to or disposed on a surface or a perimeter from the surface of the tote 325. Tote 325 can support thereon a positive busbar 315 on a side surface, or a perimeter from the side surface, of the tote 325. The interface components 320 can be curved, hooked or bent over the edge of the tote 325, or over the edge of the positive busbar 315, thereby electrically coupling the positive current collector 405 to the positive busbar 315 over the edge of the tote 325. For example, tote 325 can support or carry thereon a series busbar 410, which can be affixed to or disposed on a surface or a perimeter that is opposite to the one on which the negative and positive busbars 310 and 315 are affixed or disposed. One set of one or more interface components 320 can be curved or bent over a first edge of the tote 325 or the series busbar 410. The hooked, curved or bent interfaces 320 can electrically couple the positive current collector 405 and the series busbar 410 to each other over a first edge of the series busbar 410 or the tote 325. Another set of one or more interface components 320 can be curved or bent over a second edge of the tote 325 or the series busbar 410, thereby electrically coupling the negative current collector 305 to the series busbar 410 over a second edge of the series busbar 410 or the tote 325.

The tote 325 can include, house, enclose or comprise battery cells 120, which can be electrically coupled with the current collectors 305 and 405. Battery cells 120 can be organized within the tote 325 so that they are supported and held in place by the tote 325. Battery cells 120 in the tote 325 can be electrically coupled or connected to by components of the current collector 305 and 405. Battery cells 120 can be in electrical contacts with the busbars 310, 315 and 410 via current collectors 305 or 405.

Tote 325 can include variety of materials for providing structural support, such as any one or more metals and metal alloys, ceramics, plastics and more. Tote 325 can comprise a hollow structure and allow for one or more air flow paths for thermal management and natural convection cooling. Tote 325 can include multiple vertical and horizontal sections separate by air gaps. Tote 325 can include structures and components to provide mechanical and structural support for the battery module 115, separated by air gaps. Tote 325 can include one or more interfaces for supporting, connecting with, or coupling with any one or more of busbars 310, 315 or 405 or current collectors 305 or 405.

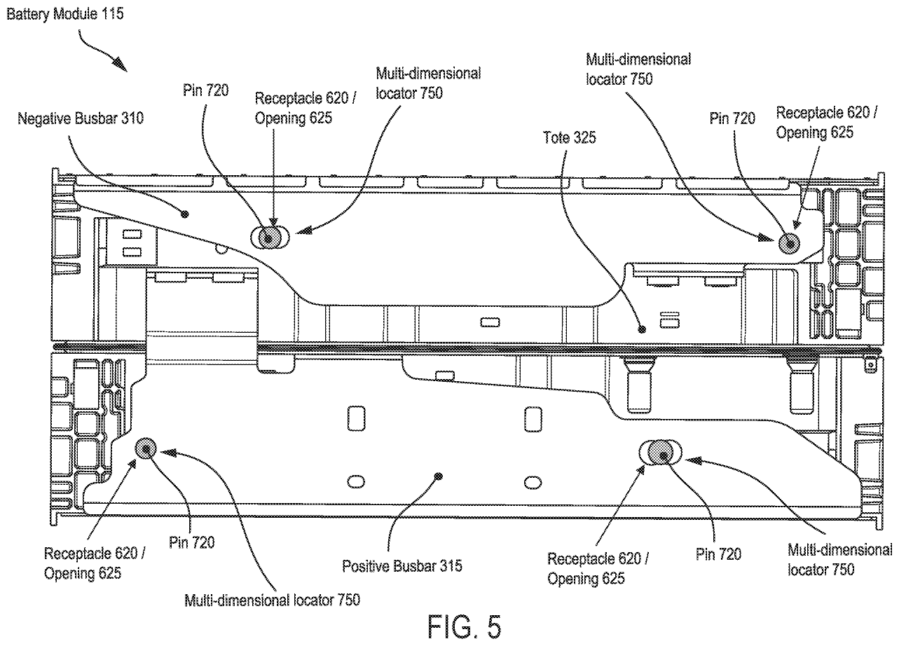

FIG. 5 depicts a view of a side of a battery module 115 having a negative busbar 310 and a positive busbar 315 interfaced and assembled with the tote 325. The negative busbar 310 and the positive busbar 315 can each include two sets of multi-dimensional locators 750. Each multi-dimensional locator 750 can include its own pin 720 and its corresponding receptacle 620 having an opening 625 into which the corresponding pin 720 can be inserted. The sets of pins 720 and their corresponding receptacles 620 can be referred to as multi-dimensional locators 750, or locators 750. Either the pin 720 or the receptacle 620 of a locator can be disposed, formed or affixed on either the tote 325 or the busbar 310, 315 or 410. Multi-dimensional locators 750 can be configured so that the opening 625 of a receptacle 620 restricts the movement of a pin 720 in two or more directions. Multi-dimensional locators 750 can include, for example, two way locators 750 or four-way locators 750. For instance, four-way locator 750 can include a set of a pin 720 and a receptacle 620 where the pin 720 can be inserted into an opening 625 of the receptacle 620 tightly so that it has no freedom of movement in any of the four directions with respect to the plane of the opening 625. For instance, a four-way locator 750 can restrict the movement of a pin 720 inside of an opening 620 so that the pin 720 cannot move, more than the permitted tolerance amount, up, down, left or right with respect to the view of the image in FIG. 5. For instance, a two-way locator 750 can include a set of a pin 720 and a receptacle 620 where the pin 720 can be inserted into an opening 625 of the receptacle 620 such that it can maneuver, or move along, a particular line or a direction, such as for example, side-to-side or up-down, while being constrained in other directions.

For example, each one of the negative busbar 310 and the positive busbar 315 can include a multi-dimensional locator 750 that is a two-way locator 750 having a pin 720 and an elongate receptacle 620. The elongate receptacle 620 can limit the movement of the pin 720 within the elongate opening 625 of the elongate receptacle 620 along a shorter or narrower dimension of the opening 625, while allowing movement of the pin 720 along a wider or longer (e.g., elongate) side. The two-way locator can restrict movement of the pin 720 within the opening 625 along a shorter diameter of the opening, allowing for movement along the longer or wider side of the opening 625. For example, each one of the negative busbar 310 and the positive busbar 315 can include a multi-dimensional locator 750 that is a four-way locator 750. The four-way locator 750 can include a pin 720 and a receptacle 620 that match or correspond to one another in shape and size in manner that can limit, reduce, or prevent the movement of the inserted pin 720 in all four directions within the opening 625. For example, a pin 720 can have a cross-section of an outer surface that corresponds to the size and shape of the opening 625 of a receptacle 620 into which it is inserted. For example, pin 720 can have a circular cross-section of 1 millimeter and it can fit into a circular 1 millimeter diameter opening 625. Likewise, pin 720 can have polygonal, circular, semi-circular, elliptical, semi-elliptical or any other shape that can correspond to the shape of its corresponding opening 625.

The negative busbar 310 can include an elongate elliptical receptacle 620 having an elongate elliptical opening 625, such as the one depicted on the left side of the negative busbar 310. The elongate elliptical opening 625 can have a width that is greater than its height. The elongate elliptical opening 625 can have its height greater than its width. A pin 720 from the tote 325 can be inserted through the elongate opening 625 of the receptacle 620. The pin 720 can correspond to the shorter side of the opening 625 to fit within the opening 625. The pin 720 can be smaller than the elongate elliptical opening 625, so as to be maneuvered or moved along the elongate side within the elongate opening 625. The elongate receptacle 620 and its elongate opening 625 can be referred to as the two-way locator. For example, a two-way locator 750 can allow for pin 720 to move side-to-side inside of the receptacle 620 on the left side of the negative busbar 310.

On a right side of the negative busbar 310 of FIG. 5, a multi-dimensional locator 750 can be provided, having a circular opening 625 into which a circular pin 720 can be inserted. The multi-dimensional locator 750 can be a four-way locator 750. The cross-section of the pin 720 and the cross-section of the opening 625 can be polygonal, elliptical or any other shape. The cross-section of the pin 720 can correspond to or match the cross-section of the opening 625. The circular pin 720 on the right side of the negative busbar 310 can have the cross-section that matches the cross-section of its corresponding opening 625 so that the pin 720 inserts tightly into the opening 625 of the right side receptacle 620, restricting the movement of the pin 720 along all four directions (up, down and side to side).

As shown for example on the right side of the illustrated example of the positive busbar 315, a multi-dimensional locator 750 can be provided having an elongate elliptical opening 625 whose width is greater than its height. The multi-dimensional locator 750 can be a two-way locator 750. A pin 720 from the tote 325 can be inserted through the elongate opening 625 of the receptacle 620 and can be smaller than the elongate elliptical opening 625, so as to be maneuvered or moved along a direction within the elongate opening 625. This elongate receptacle 620 and its elongate opening 625 of the two-way locator 750 can restrict the movement of the pin 720 along the shorter side of the elongate opening 625, while allowing for movement along the elongate side of the opening 625.

On the left side of the positive busbar 315, a multi-dimensional locator 750 that is a four way locator 750 can be provided. The four-way locator can have a circular opening 625 into which a circular pin 720 can be inserted. The cross-section of the pin 720 and the cross-section of the opening 625 can be polygonal, elliptical or any other shape. The cross-section of the pin 720 can correspond to the cross-section of the opening 625. The circular pin 720 on the left side of the positive busbar 315 can have the cross-section that matches the cross-section of its corresponding opening 625 so that the pin 720 inserts tightly into the opening 625 of the right side receptacle 620. For example, a pin 720 can have a circular cross-section having a diameter of 1 millimeter and can fit into an opening 625 of a receptacle 620 of 1 millimeter in size, within a tolerance range. As this receptacle 620 can restrict the movement of the positive busbar 315 along all four directions (up, down and side to side) of the four-way locator 750.

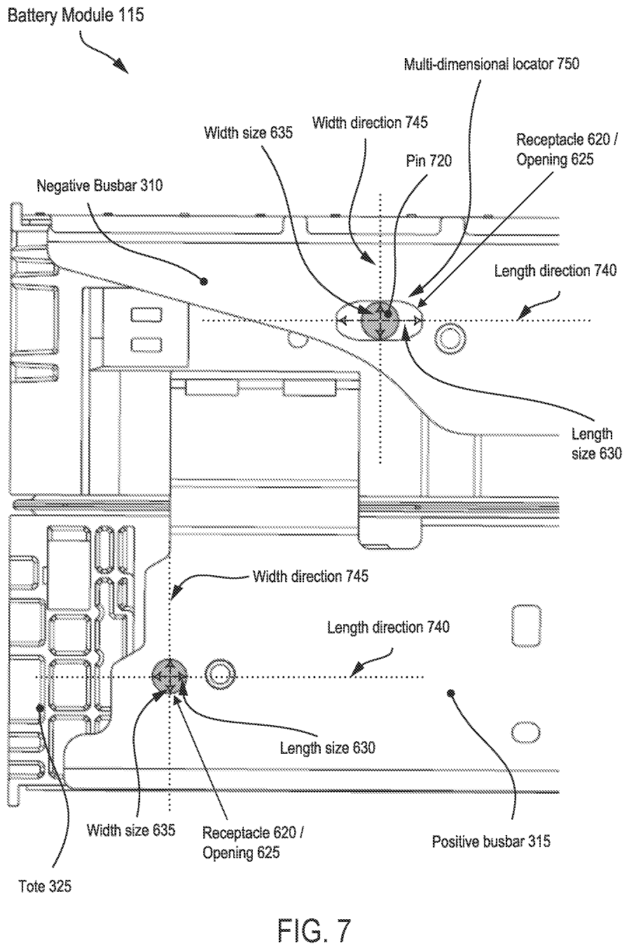

Depending on the multi-dimensional locator 750, a receptacle 620 can include any structure, object or feature for receiving a pin 720. Receptacle 620 can include a through hole, such as opening 625 (shown in FIG. 7) into and through which a pin 720 can be inserted. Receptacle 620 can include a closed cavity into which pin 720 can be inserted. The cavity can include sides of an opening, such as opening 625, past which pin 720 can be inserted and a sealed end for stopping, interfacing with or connecting with the tip of the pin 720. Receptacle 620 can include an open cavity having sides of an opening past which pin 720 can be inserted with an opening at the end of the cavity. For example, pin 720 can past through the open end. For example, the pin 720 may not reach past the open end and may be stopped by the sides of the cavity. The sides of the cavity of the receptacle 620 can be narrowed so that they stop the pin 720 as the pin 720 is inserted deeper into the receptacle 620. Receptacle 620 can include the opening 625 having a cross-section that can include any shape, such as for example, circular or elliptical, triangular, square, rectangular, pentagonal, hexagonal, octagonal, decagonal or any include the shape of any polygon. Receptacle 620 can be located or formed on, or in, a surface of a current collector 305 or 405, a tote 325, a busbar 310, 315 or 410 of the battery module 115 or any other part of the battery module 115.

Receptacle 620 can include a tolerance. The tolerance can be the same for the entire opening or different, based on direction or orientation. For example, tolerance of the opening 625 in one direction can be different than the tolerance of the opening 625 in another direction. For example, a receptacle 620 can include an opening having a first tolerance along a direction of length of the opening 625 and a second tolerance along a direction of width of the opening 625. Tolerance can include any size range defined based on the size of the opening, such as between 1% and 20% of the size of the opening. For example, tolerance can have up to 1% of the opening size, 2% of the opening size, 5% of the opening size, 10% of the opening size, 15% of the opening size, 20% of the opening size or more than 20% of the opening size. Tolerance can include any size range based on the size of the pin 720 cross-section diameter size, such as between 1-200% of the pin cross-section diameter size. For instance, tolerance can include 1%, 10%, 30%, 50%, 100%, 150%, 200% or more than 200% of the cross-sectional diameter size of pin 720. Tolerances can differ along the length and the width of the opening 625. Tolerances can differ along any direction with respect to the center of the opening 625. Tolerances can allow for the pin 720 to move when inserted into the opening 625 by one distance in one direction and by another distance in another direction.

Pin 720 can include any structure, object or feature that can be inserted into the receptacle 620. Pin 720 can include a protrusion or a projection from a surface, such as the surface of the current collector 305 or 405. Pin 720 can include a protrusion on, or a projection from, a surface, such as a surface of a tote 325, a busbar 310, 315 or 410 of a battery module 115 or any other component of the battery module 115. Pin 720 can include an elongate post or a column that can project vertically from a surface. Pin 720 can include a cross-section that is vertical to the length or height of the pin 720, which can include any shape. For example, the cross-section of the pin 720 can be, for example, circular or elliptical, triangular, square, rectangular, pentagonal, hexagonal, octagonal, decagonal or any include the shape of any polygon. The cross-section of the pin 720 can be equal across the length or height of the pin 720, or can be different. For example, the pin 720 can include a cross-section that is narrower near the top of the pin 720 than the cross-section at the middle portion or the base portion of the pin 720. Pin 720 can include the same or a different cross-section as receptacle 620 or its opening 625. For example, pin 720 can be formed or shaped to fit and entirely fill the receptacle 620. For example, pin 720 can be formed or shaped to be narrower than receptacle 620 or its opening 625, so that it has a range of movement inside the receptacle 620 or opening 625. Pin 720 can be located or formed on, or in, a surface of a current collector 305 or 405, a tote 325, a busbar of the battery module 115 or any other part of the battery module 115.

For example, a tote 325 or a busbar 310, 315 or 410 can include one, two, three, four or more than four pins 720 or one, two, three, four or more than four receptacles 620. The tote 325 or a busbar 310, 315 or 410 can include any number of combination of pins 720 and receptacles 620, such as one receptacles 620 and one pin 720 or two receptacles 620 or two pins 720. In the illustrated example, busbars 310, 315 or 410 are illustrated integrating with tote 325 via a pin 720 or receptacle 620 in each of the two sides of a tote 325 or a busbar 310, 315 or 410. The busbars 310, 315 or 410 as well as the tote 325 can comprise any shapes or sizes and can include any number of receptacles 620 or pins 720 disposed in portion of the tote 325 or busbar 310, 315 or 410.

Openings 625 of the receptacles 620 can be asymmetrical. For example, when an opening 625 has a greater length than with, the opening 620 can be asymmetrical. By combining different or differently oriented multi-dimensional locators 750 on different portions of the busbars 310, 315 or 410, the present solution can utilize asymmetrical openings to improve alignment, setting, affixing, interfacing or placement between busbars 310, 315 or 410 and the tote 325. For example, as illustrated in FIG. 5, negative busbar 310 can have on its left side a two-way locator 750 oriented along its elongate dimension left-to-right, while a four-way locator 750 can be located on the right side of the same busbar 310. The two different multi-dimensional locators 750 can act as asymmetrical openings for aligning the busbar to the tote 325. Likewise, a busbar 310, 315 or 410 can have on its one side a two-way locator 750 oriented along its elongate dimension left-to-right and another two-way locator 750 on another side of the busbar that is oriented along its elongate up-to-down. In such an example, the two asymmetrically oriented two-way locators 750 can provide asymmetrical openings for aligning the busbar 310, 315 or 410 to the tote 325. In some instances, a combination of two or more pairs of receptacles 620 and their corresponding pins 720 can form a multi-dimensional locator 750. For instance, a first pair of a pin 720 and receptacle 620 of a first two-way locator oriented in one direction and a second pair of a pin 720 and receptacle 620 of a second two-way locator oriented in another direction can together act as, or form, a multi-dimensional locator 750.

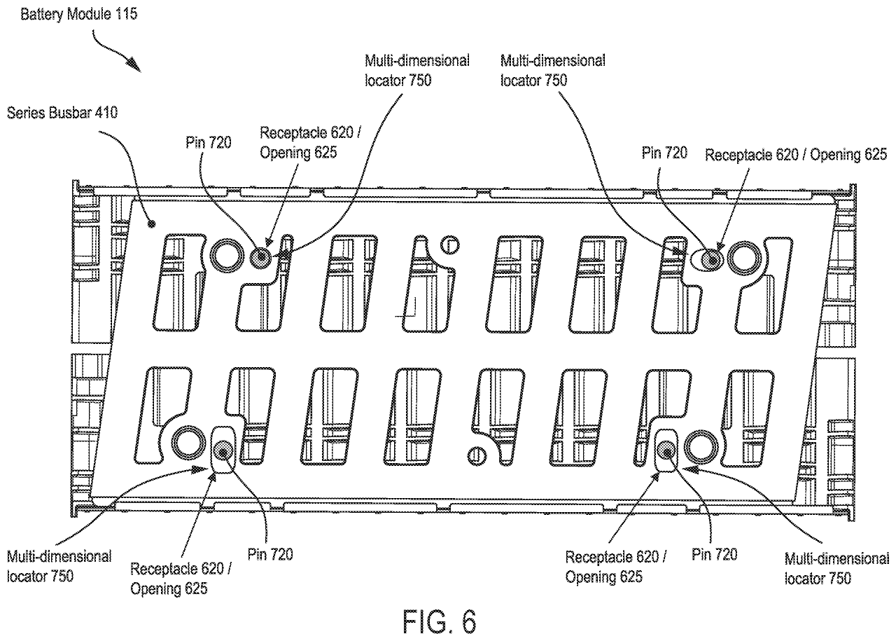

FIG. 6 illustrates an example of a side of a battery module 115 with a series busbar 410 interfaced and assembled with the tote 325. The series busbar 410 can include multiple multi-dimensional locator 750 having receptacles 620 or pins 720, each one of which can be located on either the series busbar 410 or its corresponding location on the tote 325. On the right top left corner of the series busbar 410 a four-way locator 750 having a pin 720 and a receptacle 620 can be provided. Either a pin 720 or the receptacle 620 of the four-way locator 750 can be located on the tote 325 or the busbar 410. The receptacle 620 can have a circular opening 625 (or a polygonal, elliptical or any other shaped opening) into which a pin 720 of matching shape can be inserted. The cross-section of the pin 720 and the cross-section of the opening 625 can be polygonal, elliptical or any other shape. The cross-section of the pin 720 can correspond to the cross-section of the opening 625. The circular pin 720 on the right side of the negative busbar 310 can have the cross-section that matches the cross-section of its corresponding opening 625 so that the pin 720 inserts tightly into the opening 625 of the right side receptacle 620.

In each one of the top right corner, the bottom right corner and the bottom left corner of the series busbar 410, a multi-dimensional locator 750, such as a two-way locator 750, can be provided. Each two way locator 750 can include a pin 720 that can be inserted into an elongate receptacle 620 having an elongate opening 625. The elongate opening 625 can allow for movement of the pin 720 inside of the elongate opening 625 along the elongate length. For example, in the top right corner, the pin 720 can move side-to-side (e.g., along the width of the series busbar 410. For example, in the bottom left and bottom right corners of the series busbar 410, the pin 720 can move up and down within the elongate openings 625.

Openings 625 of receptacles 620 can include any shape, such as circular, elliptical or polygonal. The opening 625 can be a through-hole opening or an opening into a closed or an open cavity into which pin 720 can be inserted. For example, an opening 625 can be an opening into a cavity having interior walls and a bottom of the cavity at which the pin 720 is stopped. For example, an opening 625 can be an opening into a cavity having an open end. The pin 720 can be made to fit through the end of the cavity or stop at a point within, or outside of, the cavity.

FIG. 7 depicts a close up of a left side of the battery module 115 illustrated in FIG. 5 in which a multi-dimensional locator 750 that is a four-way locator 750 is provided or formed on or between the positive busbar 315 and the tote 325. Another multi-dimensional locator 750 that is a two-way locator is provided or formed on or between the negative busbar 310 and the tote 325. On the positive busbar 315, a pin 720, which can be located on either the tote 325 or the busbar 315, is inserted into an opening 625 of a receptacle 620, which can be located on the remaining one of the busbar 315 or the tote 325. The pin 720 can have a circular cross-section that can match the size and shape of the opening 625. The pin 720 can be restrained within the opening 625 in all directions. The size of the opening 625 of the receptacle 620 can be measured along a length direction 740 (e.g., the length size 630) and along a width direction 745 (e.g., width size 635).

The opening 625 of the receptacle 620 can include or be defined by a length size 630 of the opening 625 and a width size 635 of the opening 625. The length size 630 can be a size of the opening 625 measured or established in a length direction 740. The width size 635 can be a size of the opening 625 measured or established in the width direction 745. The length direction 740 and the width direction 745 can be any direction, oriented in any angle with respect to the plane of the current collector 305 or 405 or the plane of the surface of the tote 325 on which they are formed. For example, the length direction 740 can be a direction along a length, width or height of the tote 325, busbar 310, 315 or 410. For example, the width direction 745 can be a direction that is different from the length direction 740 and can be along a length, width or height of the tote 325, busbar 310, 315 or 410.

For example, a length size 630 can correspond to a size of an elongate opening 625 of the receptacle 620 along a longest portion of the opening 625. The opening 625 can be an elliptical opening, a rectangular opening, a triangular opening, a square opening, or any other polygonal opening. For example, the length size 630 can include a diameter of an elongated elliptical opening along a length direction 740 that corresponds to longest diameter across the center of the elongate opening 625. For example, the direction along which a longest diameter of the elongate elliptical opening 625 is measured (e.g., length size 630) can align with, correspond to, or be parallel to, the length direction 740. The width size 635 can correspond to the size of the opening 625 along a shortest direction of an elongate elliptical opening 625 of the receptacle 620. For example, the direction along which a shortest diameter of the elongate elliptical opening 625 is measured (e.g., width size 635) can align with, correspond to, or be parallel to, the width direction 745. The width size 635 can correspond to the size of the opening 625 along a shortest direction of an elongate elliptical opening 625 of the receptacle 620.

The width direction 745 along which the width size 635 can be measured can be a different direction than the length direction 740 along which the length size 630 is measured. For example, length direction 740 can be orthogonal or perpendicular to the width direction 745. For example, length direction 740 can be at any angle from the width direction 745, between 0 and 360 degree angle. For example, length direction 740 can be offset from the width direction 745 by about 10 degrees, 20 degrees, 30 degrees, 45 degrees, 60 degrees, 70 degrees, 80 degrees or 90 degrees. For example, length direction 740 can be offset from the width direction 745 by about 100 degrees, 110 degrees, 120 degrees, 135 degrees, 150 degrees, 160 degrees, 170 degrees or 180 degrees.

Depending on the size and shape of the receptacle 620 or its opening 625, the length size 630 and width size 635 can be same or different. For example, the length size 630 and width size 635 of an opening 625 can be same length or size, such as for example when the opening 625 is circular, square, hexagonal, octagonal or any other shape that can have same sizes in multiple directions. For example, the length size 630 and width size 635 of an opening 625 can be different length or size, such as for example, when the opening 625 is rectangular, elliptical, triangular, square or polygonal with any shape that can have different sizes in multiple directions.

For example, length sizes 630 of any openings 625 on a battery module 115 can be measured along the same or a different length direction 740 used to measure the length sizes 630 of other openings 625 on the battery module 115. For example, width sizes 635 of any openings 625 on the battery module 115 can be measured along the same or a different width direction 745 used to measure width sizes 635 of any other openings 625 on the battery module 115. For example, one or more openings 625 of a battery module can have their length size 630 measured along the same length direction 740 and have their width size 635 measured along the same width direction 745. For example, one or more openings 625 of a battery module can have their length size 630 measured along a different length direction 740 and their width size 635 measured along a different width direction 745.

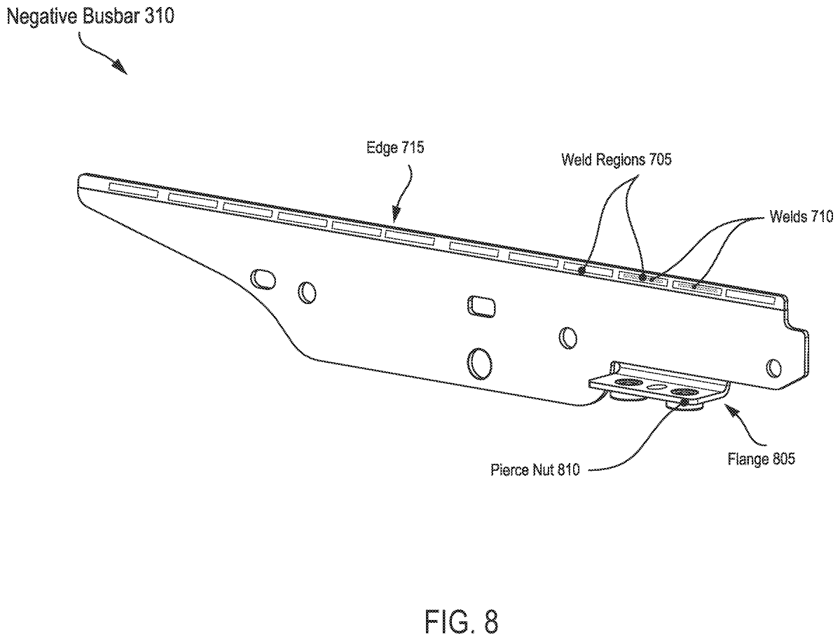

FIG. 8 depicts a negative busbar 310 that can include a metal plate comprising an edge 715 about which interfaces 320 can be curved or bent to be attached, such as via welding, to the negative busbar 310. For example, interfaces 320 can be bent or curved about or around one or more edges 715 of a negative busbar 310. Negative busbar 310 can include a front surface that can be faced away from the tote 325 when integrated into a battery module 115. Negative busbar 310 can include a back surface that is opposite to the front surface and that is turned towards the tote 325 (e.g., battery cells 120 within the battery module 115) when the negative busbar 310 is integrated into the battery module 115. On the front surface of the negative busbar 310, one or more weld regions 705 can be disposed along and proximate to the busbar edge 715. Any surface of the negative busbar 310 can include weld regions 705. For example, negative busbar 310 can include one or more the weld regions 705 on a side surface of the negative busbar 310 that is defined by the thickness of the negative busbar 310, such as along with and in proximity to the busbar edge 715 along the side surface of the negative busbar 310. Weld regions 705 and welds 710 can be set a distance apart from the busbar edge 715. Each of the weld regions 705 can include one or more welds 710 for welding interfaces 320 with the negative the negative busbar 310. Weld regions 705 can comprise any shape, such as a line, elongate rectangular, square, circular, elliptical or polygonal. Weld regions 705 can line up the front surface of the negative busbar 310 along with and proximate to the busbar edge 715. Welds 710 in the weld regions 705 can include any type and form of a weld, solder or similar coupling for connecting electrically conductive materials, such as metals. Welds 710 can comprise any shape, such as a line, elongate rectangular, square, circular, elliptical or polygonal. Welds 710 can line up the front surface of the negative busbar 310 and along with and proximate to the busbar edge 715, such as inside of the weld regions 705. Welds 710 can line up the side surface of the negative busbar 310 and along with and proximate to the busbar edge 715, such as inside of the weld regions 705 on the side surface of the negative busbar 310.

Negative busbar 310 can include a flange 805. Flange 805 can be an integral component of the negative busbar 310, such as a flange that is made from the same sheet of metal from which the negative busbar 310 is made. Flange 805 can be a component attached or affixed to the negative busbar 310, such as a sheet of metal attached, screwed, clipped or welded to the negative busbar 310. Flange 805 can extend away or be bent or curved from the plane of the flat surface of the busbar 310 that stands parallel to the tote 325 in an assembled battery module 115. For example, a flange 805 of the negative busbar 310 can curve away from the tote 325 and extend perpendicularly away from the surface of the tote 325 on which negative busbar 310 is affixed or disposed. The flange 805 can include one or more pierce nuts 810. A pierce nut 810 can include an opening for receiving screws or bolts. For example, a pierce nuts 810 can be formed through the flange 805. The pierce nut 810 can include a welded or soldered nut for a bolt attached to one or both sides or surfaces of the flange 805. The pierce nuts 810 can include threaded interior cavity through which a bolt or a screw can be inserted, twisted or screwed into and through the flange 805.

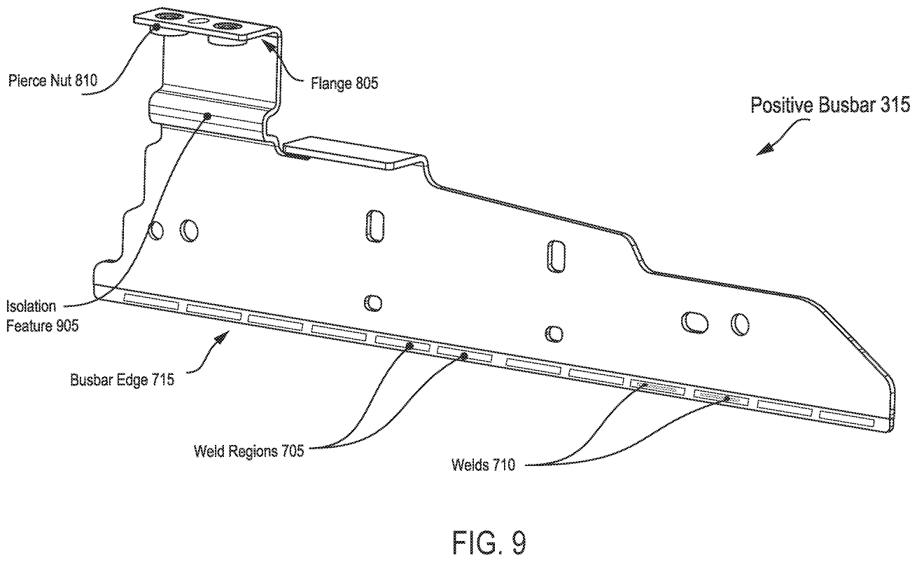

FIG. 9 depicts a positive busbar 315 that can include a metal plate comprising an edge 715 about which interfaces 320 can be attached to the positive busbar 315. Positive busbar 315 can include a front surface that can be faced away from the tote 325 when integrated into a battery module 115. Positive busbar 315 can include a back surface that is opposite to the front surface and that is turned towards the tote 325 when the positive busbar 315 is integrated into the battery module 115. On the front surface of the positive busbar 315, one or more weld regions 705 can be disposed along and proximate to the busbar edge 715. Any surface of the positive busbar 315 can include weld regions 705. For example, positive busbar 315 can include one or more the weld regions 705 on a side surface of the positive busbar 315 that is defined by the thickness of the positive busbar 315, such as along with and in proximity to the busbar edge 715 along the side surface of the positive busbar 315. Weld regions 705 and welds 710 can be set a distance apart from the busbar edge 715. Each of the weld regions 705 can include one or more welds 710 for welding interfaces 320 with the negative the positive busbar 315. Weld regions 705 can line up the front surface of the positive busbar 315 along with and proximate to the busbar edge 715. Welds 710 can line up the front surface of the positive busbar 315 and along with and proximate to the busbar edge 715, such as inside of the weld regions 705. Welds 710 can line up the side surface of the positive busbar 315 and along with and proximate to the busbar edge 715, such as inside of the weld regions 705 on the side surface of the positive busbar 315.

Positive busbar 315 can include a flange 805. Flange 805 can be an integral component of the positive busbar 315, such as a flange that is made from the same sheet of metal from which the positive busbar 315 is made. Flange 805 can be a component attached or affixed to the positive busbar 315, such as a sheet of metal attached, screwed, clipped or welded to the positive busbar 315. Flange 805 can extend away or be bent or curved from the plane of the flat surface of the busbar 310 that stands parallel to the tote 325 in an assembled battery module 115. For example, a flange 805 of the positive busbar 315 can curve away from the tote 325 and extend perpendicularly away from the surface of the tote 325 on which positive busbar 315 is affixed or disposed. The flange 805 can include one or more pierce nuts 810 for receiving and screwing one or more bolts

Isolation feature 905 can include a curvature for electrically isolating the busbar 310, 315 or 410 from one or more electrically charged features of the tote 325 or the battery module 115. For example, isolation feature 905 can include a semi-circular feature where a plane is bent into a semi-circle at a location of the busbar, such as busbar 315. Isolation feature 905 can include a bulge that extends from a plane of the busbar 310, 315 or 410 to prevent physical contact with an electrically charged element, such as an electrically charged aluminum plate of a battery module 115. The semi-circular curvature can create a space to distance the busbar 310, 315 or 410 from an electrically charged plane on a battery module 115 when the busbar is integrated with the tote 325. For example, isolation feature 905 can interrupt a flat plane of the busbar with a semi-circular curvature that bends or curves away from the plane and creates a separation or a distance with an electrically charged plate on a tote 325 or battery module 115, and then bends or curves back to provide the remainder of the busbar (e.g., 315) in the same plane. When integrated into the battery module 115, the isolation feature 905 can allow for the busbar, such as positive busbar 315, to integrate with the tote 325 having or supporting an electrically charged plate, while maintaining electrical isolation from the plate with the distance or separation created by the isolation feature 905. Busbar 310, 315 or 410 having an isolation feature 905 can include an over-molded terminal busbar that combines the functionality of an isolation bracket and a busbar into a single component.

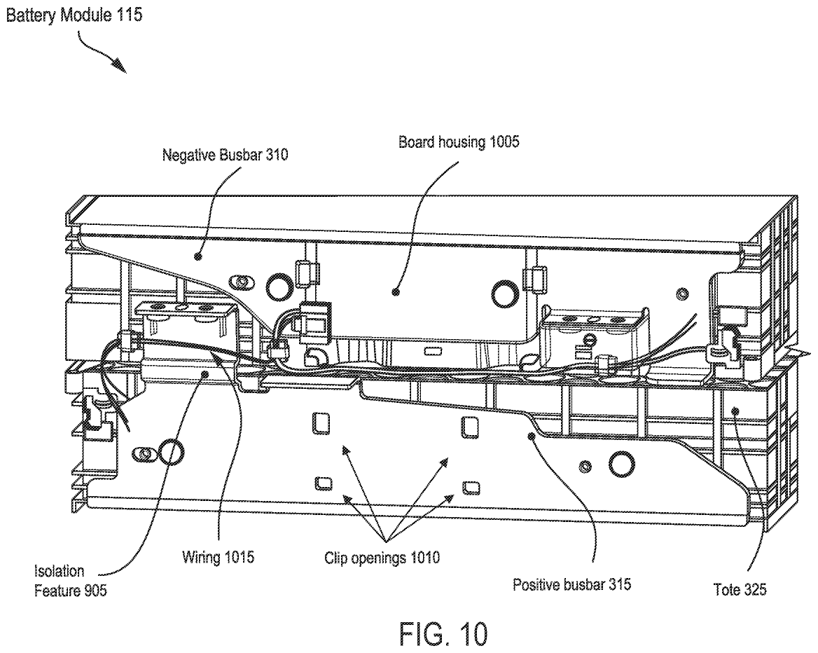

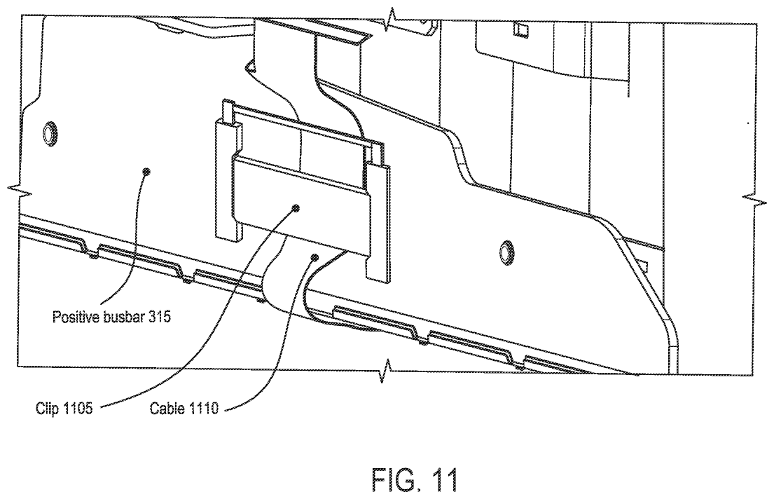

FIG. 10 depicts an example of a battery module 115 with a negative busbar 310 and a positive busbar 315 interfaced and assembled with the tote 325. Busbars 310, 315 or 410 can include a board housing 1005 for a housing or an electronic board. Busbars 310, 315 or 410 can include clip openings 1010 for holding or attaching a clip onto the positive busbar 315. Busbars 310, 315 or 410 can include one or more wires or wiring 1015. For example, negative busbar 310 can include a board housing 1005 for a housing or an electronic board. The board housing 1005 can include a holder or a housing for electronics, such as an electrical printed circuit board. For example, a positive busbar 315 can include one or more clip openings 1010 to which one or more clips can be attached. Clip openings 1010 can include through hole openings, screw holes or nuts, clip parts or any other components that can be used to attach a clip, such as a clip 1105 (shown in FIG. 11) to the busbar 310, 315 or 410. Clip 1105 can include a snap to fit clip, which can be snapped or clipped into the busbar 310, 315 or 410 via clip openings 1010. Clip 1105 can be snapped into clip openings 1010 by applying force. For example, positive busbar 315 can include one or more wires or wiring 1015 for electrical or electronics components, such as a thermistor, a sensor, such as a temperature, stress or vibration sensor, a detector, or any electrical or electronic device.

FIG. 11 depicts an example of a positive busbar 315 of a battery module 115 in which clip 1105 is attached to the positive busbar 315 (or a busbar 310 or 410) to hold a cable 1110. Clip 1105 can restrain the cable 1110 to prevent the cable 1110 from being damaged by other components or surrounding elements. Clip 1105 can attach to the busbar 315 via clip openings 1010. Clip 1105 can restrain any number of one or more cables 1110. The cable 1110 can be an electrical cable, such as a cable from a current collector 305 or 405. Cable 1110 can be an electronic signal cable, such as a cable carrying electronic communication or commands. Cable 1110 can be a harness or a cable carrying electrical power to or from the battery cells 120 of the battery module 115. Cable 1110 can include a ribbon cable.

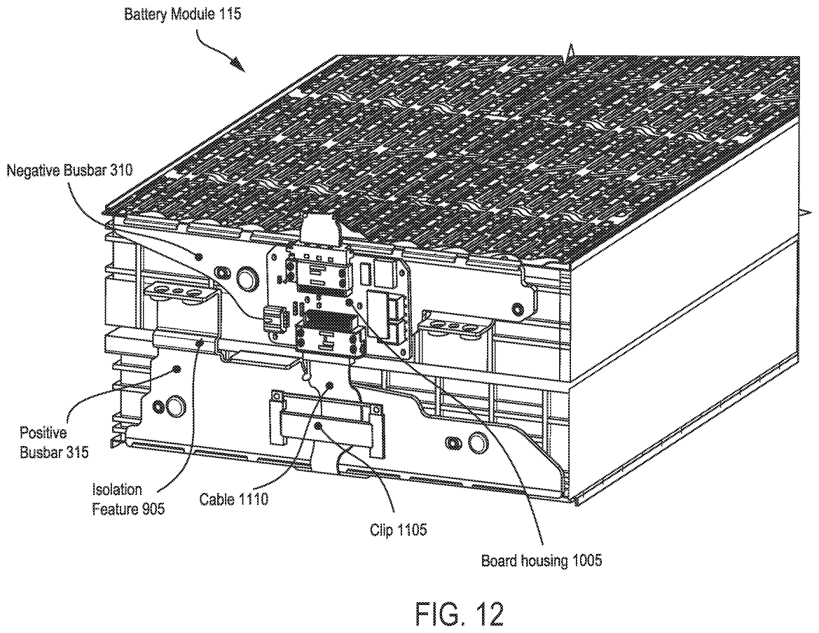

FIG. 12 depicts an example of a battery module 115 with a negative busbar 310 and positive busbar 315 interfaced into the tote 325 and the battery module 115. Isolation feature 905 of the busbar 315 can electrically isolate the positive busbar 315 from one or more electrically charged features, such as aluminum plates of the battery module 115 that can sit on or interface with the tote 325. Clip 1105 can restrain a cable 1110 that can run and attach to an electronic circuit board that can be attached or supported by board housing 1005 on the negative busbar 310. Negative busbar 310 can have a different voltage potential than the positive busbar 315 and each one can be electrically isolated from one or more features of the tote 325, such as aluminum plate that can be disposed laterally through the center of the tote 325, behind the isolation feature 905.

In some aspects, the present disclosure relates to a battery system 300 which can include any combination of one or more battery packs 110, battery modules 115 and battery cells 120. The battery pack 110 or a battery module 115 can include a busbar a busbar 310, 315 or 410 and a tote 325. The battery pack 110 can be formed by or include a single battery module 115. A battery system 300 can include a busbar 310, 315 or 410 and a tote 325. Tote 325 can be configured to align, set, affix, place, dispose or otherwise interface with the busbar 310, 315 or 410 via a multi-dimensional locator 750. The multi-dimensional locator 750 can be formed of one or more pins and one or more receptacles configured to receive the one or more pins.

The battery system 300 can include a first pin 720 located on one of the busbar 310, 315 or 320 or on the tote 325. The battery pack or a battery module 115 can include a first receptacle 620 that can be located on one of the busbar 310, 315 or 410 or the tote 325. The first receptacle 620 can include a first opening 625 having a first size (e.g., length size 630) in a first direction (e.g., length direction 740) that is greater than or equal to a first size (e.g., width size 635) of the first opening 625 in a second direction (e.g., width direction 745). The pack or a battery module 115 can include a second pin 720 that can be located on one of the busbar 310, 315 or 410 or the tote 325. The battery pack 110 or a battery module 115 can include a second receptacle 620 that can be located on one of the busbar 310, 315 or 410 or the tote 325. The second receptacle 620 can include a second opening 625 that can have a second size (e.g., length size 630) in the first direction (e.g., length direction 740) that is less than or equal to a second size (e.g., width size 635) of the second opening 625 in the second direction (e.g., width direction 745) to align, set, affix, place, dispose or otherwise interface the busbar 310, 315 or 410 with the tote 325 via the first pin 720 inserted into the first receptacle 620 and the second pin 720 inserted into the second receptacle 620.

The battery system 300 can include the multi-dimensional locator 750 that includes a 4-way locator configured to restrict relative movement between the busbar 310, 315 or 410 and the tote 325 in two dimensions. The battery system 300 can include the multi-dimensional locator 750 that includes a first two-way locator formed of a first pin 720 of the one or more pins and a first receptacle 620 of the one or more receptacles. The battery system 300 can include a second two-way locator formed of a second pin 720 of the one or more pins and a second receptacle 620 of the one or more receptacles. The battery system 300 can include the multi-dimensional locator 750 that can include a first two-way locator formed of a first pin of the one or more pins and a first receptacle of the one or more receptacles. The first receptacle 620 can include a first asymmetrical opening. The battery system 300 can include a second two-way locator formed of a second pin of the one or more pins and a second receptacle of the one or more receptacles, wherein the second receptacle comprises a second asymmetrical opening that is oriented differently than the first asymmetrical opening.

The battery system 300 can include the first pin 720 inserted into the first receptacle 620 and the second pin 720 inserted into the second receptacle 620 to establish a separation between the busbar 310, 315 or 410 and the tote 325. The first size (e.g., length size 630) of the second opening 625 of the second receptacle 620 in the first direction (e.g. length direction 740) is equal to the second size (e.g., width size 635) of the second opening 625 in the second direction (e.g., width direction 745).

The first size (e.g., length size 630) of the first opening 625 of the first receptacle 620 in the first direction (e.g., length direction 740) is greater than the first size (e.g., width size 635) of the first opening 625 in the second direction (e.g., width direction 745). The second size (e.g., length size 630) of the second opening 625 of the second receptacle 620 in the first direction (e.g., length direction 740) is less than the second size (e.g., width size 635) of the second opening 625 in the second direction (e.g., width direction 745).

The battery system 300 can include the first receptacle 620 having the first opening 625 of a cavity comprising an end. A tip of the first pin 720 can be inserted inside of the cavity to contact the end of the cavity and establish a separation between the busbar and the tote 325. The separation can be established, for example, by limiting the portion of the pin 720 which can be inserted through the opening 625, leaving the remainder of the pin 720 to establish the separation or distance between the tote 325 and the busbar 310, 315 or 410.

The battery module can include the first receptacle 620 including the first opening 625 of a through hole through which at a portion of the first pin 720 can be inserted. The busbar 310, 315 or 410 can be in electrical contact with a current collector 305 or 405. The current collector 305 or 405 can be configured to operate at a negative voltage when the battery module 115 is being discharged. For example, the negative current collector can have a voltage that is negative with respect to a ground, such as about, or up to −1V, −3V, −9V, −12V, −24V, −48V, −96V or any other negative voltage. The busbar 310, 315 or 410 can be in electrical contact with a current collector 305 or 405 that is configured to operate at a positive voltage when the battery module is being discharged. For example, the positive current collector can have a voltage that is positive with respect to a ground, such as about, or up to 1V. 3V, 9V, 12V, 24V, 48V, 96V or any other positive voltage.

The battery system 300 can include the busbar 310, 315 or 410 that can be configured to electrically connect to a first current collector 305 or 405 of the battery module 115. The first current collector 305 or 405 can be in electrical contact with a first plurality of battery cells 120 that can be configured to operate at a voltage level. A second current collector 305 or 405 can be in electrical contact with a second plurality of battery cells 120 that can be configured to operate at the same voltage level.

The battery system 300 can include a flange 805 that can include a metal plate in electrical contact with the busbar 310, 315 or 410. The battery module can include a pierce nut 810 integrated with the flange 805. A first part of the flange 805 can be in planar alignment with a portion of the tote 325. A second part of the flange 805 can include the pierce nut 810 integrated with the flange 805. The second part of the flange 805 can extend away from the busbar 310, 315 or 410.

The battery system 300 can include the busbar 310, 315 or 410 in electrical contact with a positive busbar 315 of the battery module 115. A clip 1105 can be connected with the busbar 310, 315 or 410 and configured to restrain a cable 1110. The battery module 115 can include clip 1105 attached to the busbar 310, 315 or 410 via one or more openings 1010 in the busbar 310, 315 or 410. The busbar 310, 315 or 410 can support one of a board or a housing 1005 and can be configured to support a wire 1015 for a thermistor of a battery module 115. The busbar 310, 315 or 410 can be electrically isolated from one or more aluminum plates of the battery module by an isolation feature 905.

The battery system 300 can include a multi-dimensional locator 750 that can include a first pin 720 located on one of the busbar 310, 315 or 410 or the tote 325 and a first receptacle 620 that can be located on one of the busbar 310, 315 or 410 or the tote 325. The first receptacle 620 can include a first opening 625 having a length 630 that is greater than or equal to a width 635 of the first opening 625. The length 630 can provide a first tolerance for alignment between the tote 325 and the busbar 310, 315 or 410 that is greater than a second tolerance provided by the width 635. The multi-dimensional locator 750 can include a second pin 720 that can be located on one of the busbar 310, 315 or 410 or the tote 325 and a second receptacle 620 that can be located on one of the busbar 310, 315 or 410 or the tote 325. The second receptacle 620 can include a second opening 625 having a second length 630 that is less than or equal to a second width 635 of the second opening 625 to align the busbar 310, 315 or 410 with the tote 325 via the first pin 720 inserted into the first receptacle 620 and the second pin 720 inserted into the second receptacle 620. The second length 630 can provide a third tolerance for alignment between the tote 325 and the busbar 310, 315 or 410 that is less than a fourth tolerance provided by the second width 635.

In some aspects the present disclosure relates to system 300 of an electric vehicle (EV) 105. The electric vehicle 105 can include a battery system 300. The battery system 300 can include a busbar 310, 315 or 410 and a tote 325. The tote 325 can be configured to align with the busbar 310, 315 or 410 via a multi-dimensional locator 750. The multi-dimensional locator 750 can be formed of a one or more pins 720 and one or more receptacles 620 configured to receive the one or more pins 720. The EV 105 can include a battery pack 110 of an electric vehicle 105 comprising a battery module 115. The battery module 115 can include a busbar 310, 315 or 410 of the battery module 115. The battery module 115 can include a tote 325 of the battery module to provide support for the busbar 310, 315 or 410. The battery module 115 can include a first pin 720 located on one of the busbar 310, 315 or 410 or the tote 325. The battery module 115 can include a first receptacle 620 located on one of the busbar 310, 315 or 420 or the tote 325. The first receptacle 620 can include a first opening 625 having a first size (e.g., length size 630) in a first direction (e.g., length direction 740) that is greater than or equal to a second size (e.g., width size 635) of the first opening 625 in a second direction (e.g., width direction 745) to align the busbar 310, 315 or 410 with the tote 325. The battery module 115 can include a second pin 720 that can be located on one of the busbar 310, 315 or 410 or the tote 325. The battery module 115 can include a second receptacle 620 located on one of the busbar 310, 315 or 410 or the tote 325. The second receptacle 620 can include a second opening 625 having a second size (e.g., length size 630) in the first direction (e.g., length direction 740) that is less than or equal to a second size (e.g., width size 635) of the second opening 625 in the second direction (e.g., width direction 745) to align the busbar 310, 315 or 410 with the tote 325 in at least the first direction (e.g., length direction 740) and the second direction (e.g., width direction 745) via the first pin 720 inserted into the first receptacle 620 and the second pin 720 inserted into the second receptacle 620.

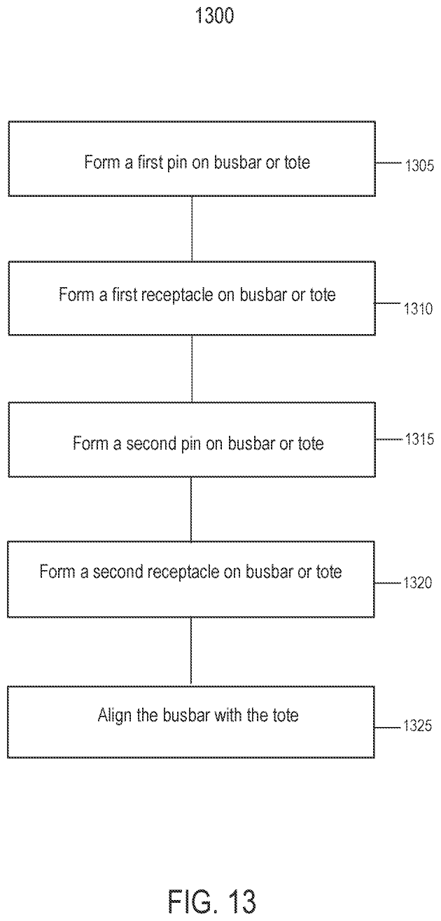

FIG. 13 depicts a method 1300 for aligning and integrating a busbar of a battery module with a tote of the battery module. The method 1300 can be performed by, for, or with a system 300, a battery module 115, a battery pack 110 or an EV 105. The method 1300 can include forming a first pin on busbar or a tote at ACT 1305. At ACT 1310, the method 1300 can include forming a first receptacle on busbar or tote. At ACT 1315, the method 1300 can include forming a second pin on busbar or tote. At ACT 1320, the method 1300 can include forming a second receptacle on busbar or tote. At ACT 1325, the method 1300 can include aligning the busbar with the tote.

At ACT 1305, the method 1300 can include forming a first pin on a busbar or a tote. The method can include forming a first pin on one of the busbar or the tote. For example, the first pin can be formed or provided on a busbar of a battery module. For example, the first pin can be formed or provided on a negative busbar, a positive busbar or a series busbar. The first pin can be formed or provided on a tote of the battery module. For example, the first pin can be formed or provided on an outer surface of the tote, such as a surface on which a busbar is to be affixed, supported or attached. The first pin can include a post, a column or a projection from a surface, such as a surface of a busbar or a tote. The first pin can include a shape of a spherical or semispherical bump, a cylinder, a pyramid or a prism. At ACT 1310, the method 1300 can include forming a first receptacle on busbar or tote. The method can include forming, on one of the busbar or the tote, a first receptacle. The first receptacle can include a first opening. The first opening can have a first size in a first direction that is greater than or equal to a first size of the opening in a second direction. The first receptacle can include an opening for a two-way locator. For example, the first receptacle can include an elongate opening that has a first size along the elongate direction or side of the opening that is greater than a second size of the opening along a shorter direction or side of the opening. The first opening can include a cross-section of the opening in the shape of a circle, an ellipse, a triangle, a rectangle, a square, a hexagon, an octagon, a decagon, a dodecagon or any other polygonal shape. The first receptacle can include an opening for a four-way locator. For example, the first receptacle can include an elongate opening that has a first size along one direction be equal in length to the second size along a second direction of the opening. The first size can be measured along a first direction and a second size can be measured along a second direction. The first direction can be different from the second direction. The first direction can be perpendicular or orthogonal to the second direction. The first receptacle can be provided on the tote of the battery module. The first receptacle can be provided on the busbar of the battery module, such as the negative busbar, positive busbar or the series busbar.

The method can include extending, by a flange comprising a metal plate in electrical contact with a busbar, away from the busbar a portion of the flange. The portion of the flange can include a pierce nut integrated with the flange. The pierce nut can include a threaded screw hole for a bolt or a screw. The method can include connecting, by a busbar, a clip to the battery module. For example, the clip can be a clip attached to a busbar, such as a positive busbar, a negative busbar or the series busbar. The method can include restraining, by the clip, a cable connected to the battery module. For example, the cable can include a cable to an electronic board on a negative busbar, a positive busbar or a series busbar. The cable can include a power cable or an electronic communication signal cable. The method can include supporting, by the busbar, one of a board or a housing. For example, the busbar can support an electronics board or a printed circuit board on or in a housing of a busbar. The method can include supporting, by the busbar, a wire for a thermistor of the battery module. For example, a positive busbar, a negative busbar or a series busbar can support thereon a wire for a thermistor, a heat or a temperature sensor, a detector, a pressure sensor. A thermistor can refer to or include an electrical resistor whose resistance is reduced by heating, and can be used to sense, detect, or otherwise identify temperature.

The method 1300 can include providing a busbar of a battery system. The method can include providing a tote of the battery system. The tote can be configured to align with the busbar via a multi-dimensional locator. The multi-dimensional locator can be formed of a one or more pins and one or more receptacles configured to receive the one or more pins. The method can include providing a first two-way locator formed of a first pin of the one or more pins and a first receptacle of the one or more receptacles. The first receptacle can include a first asymmetrical opening. The method can include providing a second two-way locator formed of a second pin of the one or more pins and a second receptacle of the one or more receptacles. The second receptacle can include a second asymmetrical opening that is oriented differently than the first asymmetrical opening.

The method can include the multi-dimensional locator having a first pin located on one of the busbar or the tote and a first receptacle located on one of the busbar or the tote. The first receptacle can include a first opening having a length that is greater than or equal to a width of the first opening. The multi-dimensional locator can include a second pin located on one of the busbar or the tote and a second receptacle located on one of the busbar or the tote. The second receptacle can include a second opening having a second length that is less than or equal to a second width of the second opening to align the busbar with the tote via the first pin inserted into the first receptacle and the second pin inserted into the second receptacle.

At ACT 1315, the method 1300 can include forming a second pin on busbar or tote. The method can include forming a second pin on one of the busbar or the tote. The second pin can include a post, a column or a projection from a surface, such as a surface of a busbar or a tote. The second pin can include a shape of a spherical or semispherical bump, a cylinder, a pyramid or a prism. The second pin can be formed or provided on one of the busbar or the tote. For example, the second pin can be formed or provided on a busbar of a battery module. For example, the second pin can be formed or provided on a negative busbar, a positive busbar or a series busbar. The second pin can be formed or provided on a tote of the battery module. For example, the second pin can be formed or provided on an outer surface of the tote, such as a surface on which a busbar is to be affixed, supported or attached.

At ACT 1320, the method 1300 can include forming a second receptacle on busbar or tote. The method can include forming, on one of the busbar or the tote, a second receptacle. The second receptacle can include a second opening having a second size in the first direction that is greater than or equal to a second size of the opening in the second direction.

The second receptacle can include an opening for a two-way locator. For example, the second receptacle can include an elongate opening that has a first size along the elongate direction or side of the opening that is greater than a second size of the opening along a shorter direction or side of the opening. The second opening can include a cross-section of the opening in the shape of a circle, an ellipse, a triangle, a rectangle, a square, a hexagon, an octagon, a decagon, a dodecagon or any other polygonal shape. The second receptacle can include an opening for a four-way locator. For example, the second receptacle can include an elongate opening that has a first size along one direction be equal in length to the second size along a second direction of the opening. The first size can be measured along a first direction and a second size can be measured along a second direction. The first direction can be different from the second direction. The first direction can be perpendicular or orthogonal to the second direction. The second receptacle can be provided on the tote of the battery module. The second receptacle can be provided on the busbar of the battery module, such as the negative busbar, positive busbar or the series busbar.

At ACT 1325, the method 1300 can include aligning the busbar with the tote. The method can include aligning the busbar with the tote via the first pin inserted into the first receptacle and the second pin inserted into the second receptacle. For example, a busbar can be aligned with the tote in at least two directions using a two-way locator. The two-way locator can include a pin on one of the tote or the busbar and a receptacle having an opening on the remaining one of the busbar or the tote, such that the opening has a size in one direction greater than the size of the opening in another direction. The busbar can be further aligned by inserting a second pin into a second opening of the second receptacle and restricting the movement of the busbar with respect to the tote in all directions.

The method 1300 can include separating, by the first pin inserted into the first receptacle and the second pin inserted into the second receptacle, a separation between the busbar and the tote. For example, a pin can be inserted into a receptacle having an opening for a cavity having a closed end. The distance between the top of the cavity and the end of the cavity can define the depth or the length of the pin that can be inserted, leaving the remainder of the pin to define the separation between the busbar and the tote. For example, multiple pins inserted into multiple cavities and having portions of the pins disposed between the busbar and the tote can define the distance or separation between the busbar and the tote. The method can include aligning the busbar with the tote via the first pin inserted into the first receptacle and the second pin inserted into the second receptacle in at least the first direction and the second direction.

This present application is related to a co-pending application titled “Interface for a Current Collector and a Busbar in a Battery” filed concurrently with the present application and identified by Attorney Docket No. 131680-0171 and a co-pending application titled “Interface for Integrating a Current Collector into a Battery Assembly” filed concurrently with the present application and identified by Attorney Docket No. 131680-0191, both of which are incorporated by reference herewith in their entirety and for all purposes.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, negative busbar and a positive busbar can be reversed, as well as negative current collector and the positive current collector. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery system, comprising:
a busbar; and
a tote configured to align with the busbar via a multi-dimensional locator, wherein the multi-dimensional locator comprises one or more pins and one or more receptacles configured to receive the one or more pins.

2. The battery system of claim 1, wherein the multi-dimensional locator comprises a 4-way locator configured to restrict relative movement between the busbar and the tote in multiple dimensions.

3. The battery system of claim 1, wherein the multi-dimensional locator comprises:
a first two-way locator formed of a first pin of the one or more pins and a first receptacle of the one or more receptacles; and
a second two-way locator formed of a second pin of the one or more pins and a second receptacle of the one or more receptacles, wherein the first pin is inserted into the first receptacle and the second pin is inserted into the second receptacle to interface the busbar with the tote.

4. The battery system of claim 1, wherein the multi-dimensional locator comprises:
a first two-way locator formed of a first pin of the one or more pins and a first receptacle of the one or more receptacles, wherein the first receptacle comprises a first asymmetrical opening; and
a second two-way locator formed of a second pin of the one or more pins and a second receptacle of the one or more receptacles, wherein the second receptacle comprises a second asymmetrical opening that is oriented differently than the first asymmetrical opening.

5. The battery system of claim 1, wherein the multi-dimensional locator comprises:
a first pin located on one of the busbar or the tote;
a first receptacle located on one of the busbar or the tote, the first receptacle comprising a first opening having a length that is greater than or equal to a width of the first opening, wherein the length provides a first tolerance for alignment between the tote and the busbar is greater than a second tolerance provided by the width;
a second pin located on one of the busbar or the tote; and
a second receptacle located on one of the busbar or the tote, the second receptacle comprising a second opening having a second length that is less than or equal to a second width of the second opening to align the busbar with the tote via the first pin inserted into the first receptacle and the second pin inserted into the second receptacle, wherein the second length provides a third tolerance for alignment between the tote and the busbar that is less than a fourth tolerance provided by the second width.

6. The battery system of claim 1, wherein the 4-way locator establishes a separation between the busbar and the tote.

7. The battery system of claim 1, comprising:
the busbar configured to electrically connect to:
a first current collector of the battery system in electrical contact with a first plurality of battery cells configured to operate at a voltage level; and
a second current collector of the battery system in electrical contact with a second plurality of battery cells configured to operate at the voltage level.

8. The battery system of claim 1, comprising:
a flange comprising a metal plate in electrical contact with the busbar; and
a pierce nut integrated with the flange.

9. The battery system of claim 1, comprising:
a flange having a first part that is in planar alignment with a portion of the tote; and
the flange having a second part comprising a pierce nut integrated with the flange, wherein the second part of the flange extends away from the busbar.

10. The battery system of claim 1, comprising:
the busbar in electrical contact with a positive terminal of a battery of the battery system; and
a clip connected with the busbar and configured to restrain a cable.

11. The battery system of claim 1, comprising:
a clip connected with the busbar and configured to restrain a cable, wherein the clip attaches to the busbar via one or more openings in the busbar.

12. The battery system of claim 1, comprising:
the busbar to support one of a board or a housing and configured to support a wire for a thermistor of the battery system.

13. The battery system of claim 1, comprising:
the busbar to electrically isolate from one or more aluminum plates of the battery system.

14. A method, comprising:
providing a busbar of a battery system;
providing a tote of the battery system;
providing a multi-dimensional locator, wherein the multi-dimensional locator comprises one or more pins and one or more receptacles configured to receive the one or more pins; and
aligning the busbar with the tote via the multi-dimensional locator.

15. The method of claim 14, wherein the multi-dimensional locator comprises a 4-way locator configured to restrict relative movement between the busbar and the tote in two dimensions.

16. The method of claim 14, comprising:
providing a first two-way locator formed of a first pin of the one or more pins and a first receptacle of the one or more receptacles; and
providing a second two-way locator formed of a second pin of the one or more pins and a second receptacle of the one or more receptacles.

17. The method of claim 14, comprising:
providing a first two-way locator formed of a first pin of the one or more pins and a first receptacle of the one or more receptacles, wherein the first receptacle comprises a first asymmetrical opening; and
providing a second two-way locator formed of a second pin of the one or more pins and a second receptacle of the one or more receptacles, wherein the second receptacle comprises a second asymmetrical opening that is oriented differently than the first asymmetrical opening.

18. The method of claim 14, wherein the multi-dimensional locator comprises:
a first pin located on one of the busbar or the tote;
a first receptacle located on one of the busbar or the tote, the first receptacle comprising a first opening having a length that is greater than or equal to a width of the first opening;
a second pin located on one of the busbar or the tote; and
a second receptacle located on one of the busbar or the tote, the second receptacle comprising a second opening having a second length that is less than or equal to a second width of the second opening to align the busbar with the tote via the first pin inserted into the first receptacle and the second pin inserted into the second receptacle.

19. An electric vehicle, comprising:
a battery system comprising:
a busbar; and
a tote configured to align with the busbar via a multi-dimensional locator, wherein the multi-dimensional locator is formed of a one or more pins and one or more receptacles configured to receive the one or more pins.

20. The electric vehicle of claim 19, wherein the multi-dimensional locator comprises a 4-way locator configured to restrict relative movement between the busbar and the tote in two dimensions.
